(19) United States
(12) Patent Application Publication
(10) Pub. No.: US 2012/0191584 A1
(43) Pub. Date: Jul. 26, 2012

(54) System And Method For Lender Directed Voting

(76) Inventors: Edmon W. Blount, Gold Canyon, AZ (US); Robert Daigle, Montclair, VA (US)

(21) Appl. No.: 13/309,079

(22) Filed: Dec. 1, 2011

Related U.S. Application Data
(60) Provisional application No. 61/419,036, filed on Dec. 2, 2010.
(60) Provisional application No. 61/503,962, filed on Jul. 1, 2011.

(51) Int. Cl. G06Q 40/00

(52) U.S. Cl. 705/35

(57) ABSTRACT

Systems and methods for assigning a company's proxies associated with a company's shares from a financial intermediary to a lender are disclosed. In accordance with an aspect of the invention a system includes a memory and a processor. The memory stores a number of the company's shares for which the financial intermediary has not received proxy voting instructions and, for a plurality of lenders, the number of the company's shares loaned by the lender. The processor has access to the memory and determines a number of the company's proxies for which the financial intermediary has not received proxy voting instructions to assign to at least some of the plurality of lenders based on the number of company's shares for which the financial intermediary has not received voting instructions and based on the number of shares loaned by the lender.

### CROSS REFERENCE TO RELATED PATENT APPLICATIONS

This application claims the benefit of U.S. Provisional Patent Application Ser. No. 61 /419,036, filed Dec. 2, 2010 and of U.S. Provisional Patent Application Ser. No. 61/503,962, filed Jul. 1, 2011, the entireties of which are incorporated herein by reference.

### TECHNICAL FIELD

This invention relates to systems and methods to process securities lending activities within the global capital markets system.

### BACKGROUND

Securities lending is a financial market transaction in which an owner of a security loans that security to a broker borrower who may use it for several reasons, as described below. The borrower transfers collateral (either cash or other securities) to the lender to secure the loan. Lenders generally contract with securities lending agents to negotiate loan terms with brokers, invest collateral, and manage lending program risks. Securities lending markets have existed for hundreds of years in parallel with the stock and derivatives trading markets and are overseen by several government regulatory agencies.

One shortcoming of securities lending, however, is that the right to vote shares in corporate elections transfers from the lender with the loan. Accordingly, owners who lend their shares lose the right to vote in proxy events. The only means by which a lender may reacquire voting rights is to recall the securities, terminate the loan, and therefore lose the associated lending revenue.

Brokers typically borrow securities to prevent disruptions in the chain of security buys and sells or to cover short sales. For example, if a broker-dealer fails to receive securities that its customers or traders have bought in the stock market, then the broker may be unable to make deliveries for the firm's own sales. To avoid such delivery failures, a broker can arrange to borrow securities and use the borrowed securities to settle security deliveries.

To borrow shares, brokers can access several securities lending sources. Securities can be borrowed from the broker's own proprietary holdings created from the broker's trading, market-making and hedging operations. Shares can also be borrowed from brokers' margin customers, including hedge funds, who agree that their securities can be loaned out as a condition of the margin financing relationship. Often, however, internal sources are inadequate and brokers must borrow shares from other brokers or institutional investors.

The most reliable source of borrowed shares is long-term, institutional investors. These positions, which are borrowed under a master securities lending contract between the institutional investor and the broker, tend to be the most stable. By contrast, securities borrowed from margin accounts or other brokers may have to be returned unexpectedly, especially when market activity grows rapidly, just as the firm's own failures-to-receive may increase. Therefore, institutional securities loans are not only highly desirable to brokers, but are also important contributors to operational stability in active stock markets.

Brokers, however, do not currently grant institutional investors the same proxy voting privileges as are granted to other beneficial owners who are also contractual lenders to the brokers, even though securities of both groups are often combined for delivery purposes. For example, margin customers may often vote proxies for securities that are on loan. As a result, institutional investors have to recall their loaned shares in order to cast proxy votes, thereby disrupting the stability of the broker and the financial markets.

Furthermore, a misalignment in corporate interests can result from the right to vote borrowed securities being granted to margin customers of the broker, but withheld from institutional investors. For example, activist hedge funds may purchase shares through margin accounts that have been partially financed by brokers. After building a position with limited cost, the hedge fund managers may vote for or against corporate actions, such as mergers and divestitures, in ways that may actually work against the long-term economic interests of corporate management, boards of directors, employees, unions and the institutional investors whose shares are on loan. Furthermore, activist hedge funds may have neutralized, or reversed their economic interest in the corporation through the use of options, swaps and other derivatives. This has been termed “empty voting” by academics.

Accordingly, systems and methods to provide lender-directed voting to address these and other shortcomings, are needed.

### SUMMARY OF THE INVENTION

Lender-Directed Voting (LDV), in accordance with aspects of the present invention, helps resolve the issues identified above by enabling lenders to instruct proxies for shares that would otherwise go un-voted that are held by financial intermediaries such as brokers, custodians, lending agents, central clearing agencies, electronic securities lending hubs, proxy advisory or processing firms, and other financial market service providers.

LDV will help level the corporate governance playing field by providing a systematic process that allows the long-term interests of corporate management, boards of directors and their institutional shareholders to be balanced against the short-term interests of other investors, such as activist hedge funds. Furthermore, LDV will help corporate managers and their boards to better engage long-term institutional shareholders in the corporate governance process. Corporate issuers can also receive many more proxy votes from long-term investors with positive economic interests, reducing time and costs of reaching quorum in corporate elections and better aligning votes cast with beneficial ownership.

Furthermore, institutional investors will, in many cases, no longer have to choose between their corporate governance responsibilities and important fee income from securities lending. Those who currently prioritize income would no longer have to forgo voting rights, while others could continue to vote proxies while generating more revenue from securities lending. According to industry surveys, securities lending in 2010 generated more than $4 billion in additional portfolio revenue for institutional investors and their beneficiaries, thereby helping to overcome funding and competitive pressures.

Securities lending agents and financial intermediaries, such as brokers and custodians, can gain more stable loan, borrow, and collateral portfolios, which in turn would decrease investment, operational, and systemic risks.

General investors can also benefit from capital markets with increased liquidity and improved price discovery, both of which have been consistently shown to be enhanced by securities lending. By restoring the voting franchise to concerned institutional investors, the frequency of loan recalls is reduced significantly. Furthermore, brokers' ability to borrow securities improves their functioning in many ways, according to a report of the Committee on Payment and Settlement Systems (CPSS) of the Bank for International Settlements and the Technical Committee of the International Organization of Securities Commissions (IOSCO), which recommended that securities lending and borrowing should be encouraged as a method for expediting the settlement of securities transactions.

In accordance with an aspect of the present invention, a method of assigning a company's proxies associated with a company's shares from a financial intermediary to a lender is provided. The method includes the steps of a processor determining a number of the company's shares for which the financial intermediary has not received proxy voting instructions, the processor determining for a plurality of lenders, the number of the company's shares loaned by each of the lenders and, for each of the plurality of lenders, the processor calculating the number of proxies to assign to at least some of the company's proxies for which the financial intermediary has not received proxy voting instructions to at least some of the plurality of lenders based on the number of company's shares for which the financial intermediary has not received voting instructions and based on the number of shares loaned by the lender.

In accordance with further aspects of the present invention, the processor's assignment of the number of proxies of un-voted shares by the financial intermediary is constrained by: the lender's percentage share of assigned votes is equivalent to its percentage share of loan volume and a lender can receive no more votes than it has loans outstanding.

The financial intermediary can be a broker and the steps of claim 1 are performed for a plurality of brokers. In accordance with a further aspect of the present invention, each of the plurality of brokers can assign no more of the company's proxies than it has for which it has not received proxy voting instructions. A constraint the processor enforces is that brokers can only assign to lenders votes equaling the number of shares they have borrowed from those lenders.

The processor, in accordance with another aspect of the present invention assigns at least some of the number of the financial intermediary's un-voted proxies based on execution of a linear programming optimization model that maximizes the number of the financial intermediary's un-voted proxies that are voted.

In accordance with other aspects of the present invention, the financial intermediary can be a custodian. In this case, the processor determines a number of the company's shares for which a custodian has not received proxy voting instructions and determines for a plurality of lenders, the number of the company's shares held by the custodian on behalf of lenders that are loaned by the lender. For each of the plurality of lenders, the processor assigns at least some of the number of the company's proxies for which the custodian has not received proxy voting instructions to each one of the plurality of lenders based on the number of company's proxies for which the custodian has not received voting instructions and based on the number of shares held by the custodian on behalf of lenders that are loaned by the lender.

In accordance with a further aspect of the present invention, the financial intermediary is a broker and, prior to the steps of claim 1 being performed (for example one to three months before), a processor forecasts a number of the company's shares for which the broker will not receive proxy voting instructions, determines a proposed loan allocation of the company's shares between the plurality of lenders and the broker by using the forecasted number of the company's shares for which the broker will not receive proxy voting instructions and loans of the company's shares between a plurality of lenders and the broker and transmits the proposed loan allocation to a third party. In most cases, the proposed loan allocation of the company's shares between the plurality of lenders and the broker is different than an actual loan allocation of the company's shares between the plurality of lenders and the broker.

In accordance with an aspect of the present invention, the processor forecasts the number of the company's shares for which the broker will not receive proxy voting instructions by performing a multiple regression analysis on parameters selected from a group consisting of: a number of broker proprietary shares, a number of broker customer long shares, a number of broker customer margin shares, a measure of a type of the broker's customer base and proprietary voting preferences, a measure of a contentiousness of a proxy, and a market price for a loan of the company's shares. Other factors that may be included in the regression include the market capitalization, float, trading volume, and institutional ownership of the security, the materiality of the proxy agenda, aggregate securities lending volume for the security, and the historical LDV history of the lender and the broker.

In accordance with a further aspect of the present invention, the financial intermediary is a custodian, and, prior to the steps of claim 1 being performed, a processor forecasts a number of the company's shares for which the custodian will not receive proxy voting instructions by performing a multiple regression analysis on parameters selected from a group consisting of: a number of shares held by custodian, a measure of a type of the custodian's customer base, a measure of a contentiousness of a proxy, and a market price for a loan of the company's shares. As above, additional factors may be included in the multiple regression.

Systems having one or more processors, memory and displays to implement the methods described above are also contemplated.

### DESCRIPTION OF THE DRAWINGS

FIG. 1 illustrates a loan initiation process that is currently used.

FIGS. 2 and 3 illustrate systems used in accordance with an embodiment of the present invention.

FIG. 4 illustrates a loan recall and termination process commonly used today.

FIG. 5 illustrates a lender-directed voting process in accordance with aspects of the present invention.

FIG. 6 illustrates a lender-directed voting central processor in accordance with aspects of the present invention.

FIGS. 7A to 7B illustrates a lender-directed voting process in accordance with aspects of the present invention.

FIGS. 8A to 8C illustrates a lender-directed voting data processing in accordance with aspects of the present invention.

FIG. 9 illustrates a timeline in accordance with aspects of the present invention.

FIG. 10 illustrates a computational engine 1 (E1) implemented by processors in accordance with aspects of the present invention.

FIG. 11 illustrates a computational engine 2 (E2) implemented by processors in accordance with aspects of the present invention.

FIG. 12 illustrates a computational engine 3 (E3) implemented by processors in accordance with aspects of the present invention.

FIG. 13 illustrates outputs from a central processor in accordance with an aspect of the present invention.

FIGS. 14, 15, and 16 illustrate the outputs of the various lender-directed voting computational engines in accordance with various aspects of the present invention.

### DESCRIPTION

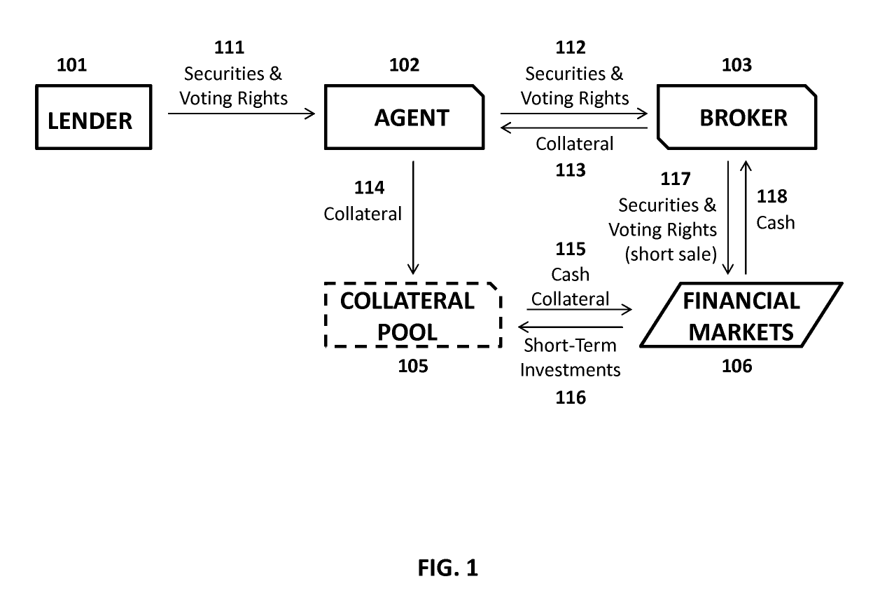

FIG. 1 illustrates a loan initiation process currently used. As illustrated, loaned securities are ultimately made available to a Broker 103 for purposes such as support of short sales of securities. Presently, a Lender 101 makes securities available to an Agent 102 to lend (i.e., provides loan supply) securities to a Broker 103. In this lending process, the Lender 101 forgoes voting rights, which transfer with loaned securities in a step 111. An Agent 102 negotiates loan terms (e.g., volume, price, collateral) with Broker 103, then transfers, in a step 112, securities and voting rights to Broker 103. In a step 113, a Broker 103 transfers collateral to an Agent 102, which usually manages collateral (including investing cash) on behalf of Lender 101 in one or more steps 114 in a Collateral Pool 105. The Broker 103 delivers the securities to other parties for various purposes, such as executing short sale transactions 116 into Financial Markets 106 to generate cash from Financial Markets 106 in step 117 for collateral. The voting rights transfer to the end receiver of the securities and are therefore are not retained by the broker 103. The broker 103 also negotiates security loan terms with the Agent 102.

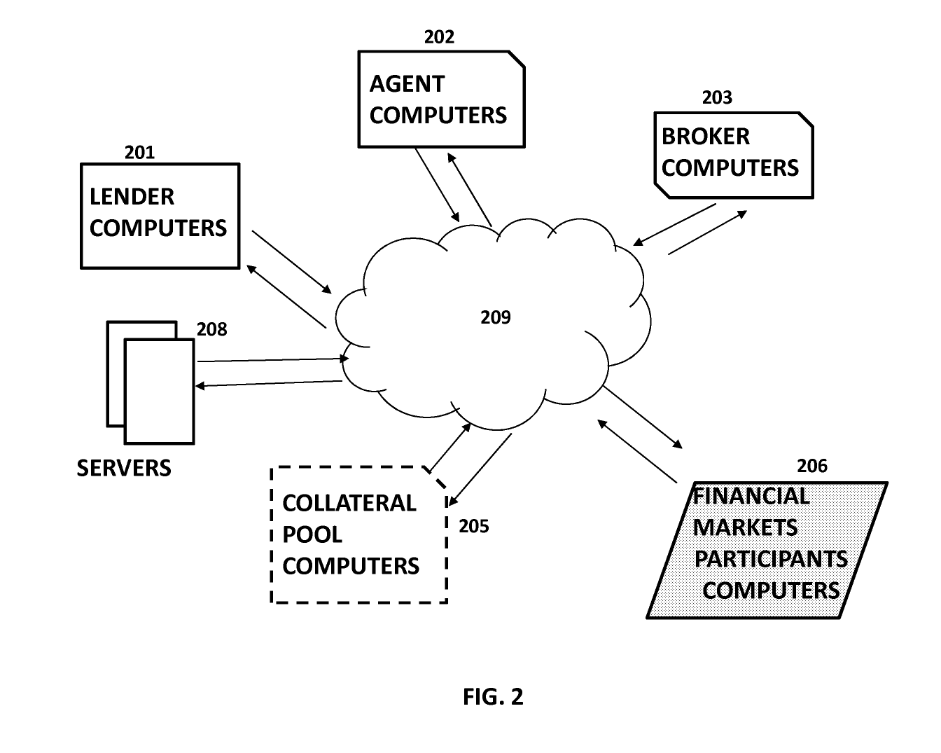

Nowadays all transactions in securities lending can and usually are performed by computer systems that are connected with each other via a network. This is illustrated in FIG. 2 wherein the steps 111, 112, 113, 114, 115, 116, 117 and 118 are performed by electronic messaging including fund transfers and securities transfers and other rights transfers between Lender Computers 201, Agent Computers 202, Broker Computers 203, Collateral Pool Computers 205 and Financial Markets Participant Computers 206 which are all connected to a network 209 which may be the Internet. Also included are Servers 208 connected to network 209 which support and enable the electronic transfer of messages between participating and connected computers. In one embodiment of the present invention, a server 208 implements a one or more databases. In a further embodiment of the present invention, a database is a distributed database which is distributed over participating computers in the system. In such a distributed system, a processor that has to perform instructions in accordance with an aspect of the present invention is enabled to access a database on a single server or a distributed database to perform the required steps.

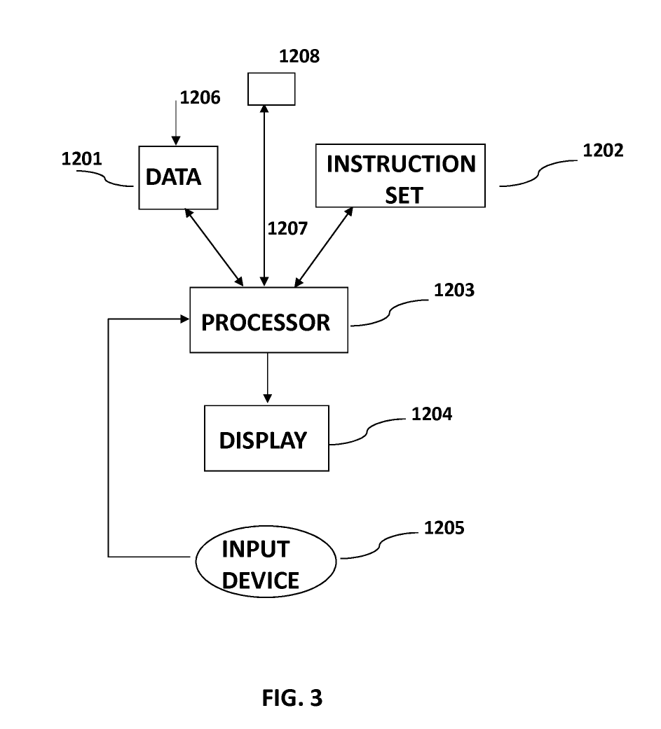

The steps as explained above and those steps of the present invention, to be describe later, can be executed by a system or computing device as shown in FIG. 3. The system is provided with data which are provided on an input 1206 and which is stored on a memory or storage device 1201. An instruction set or program 1202 also stored on a memory or a storage device executing the methods of the present invention is provided and combined with the data in a processor 1203, which can process the instructions of 1202 applied to the data 1201. Any signal resulting from the processor can be outputted on a device 1204. Such a device for instance can be a display. However, in an operational situation such device may also be an output device to provide a message to a network or a network connection to another computing device. In a further embodiment of the present invention 1204 may include a storage device or memory to retain data for later retrieval. The processor can be dedicated hardware. However, the processor can also be a CPU or any other computing device that can execute the instructions of 1202. An input device 1205 like a mouse, or track-ball or other input device may be present to allow a user to select an object on a display. The input device may also be a keyboard to enter data. The input device may also be used to start or stop instructions and activate applications on the processor. In a further embodiment of the present invention the system or computing device is connected via a connection 1207 to a network, for instance via a network device 1208 which may implement a network interface. Accordingly the system or computing device as shown in FIG. 3 provides a device that can be applied to perform one or more transactions, send or receive and store and retain one or more messages or documents related to securities lending. In accordance with an aspect of the present invention a processor is part of a computing device. Such a computing device may be a computer, a server, a database machine, a mobile phone, a Personal Digital Device (PDA), a laptop, a smart phone, a media player, a tablet, an eReader, or any other device that has a processor and that is enabled to receive and process data and to send data or that can easily be modified or configured or programmed to perform at least some of the functions or methods of the present invention.

Every step in a transaction between the computers related to securities lending and to any other aspect of the present invention generates a message or a record that is stored on a computer or a database and is retrievable. A database is a storage medium which stores data and which retrieves data, usually under direction of a processor. Data stored on a database can be accessed by the processor and can be processed to create for instance new data which can be stored on the database. Data on a database can be arranged in a predetermined way to enable related data to be associated with each other or for data to be indexed or preprocessed in any way as is known in the art of database management and distributed database management.

Accordingly, each step of the securities lending process is at least accompanied, if not completely performed, by a system as shown in FIG. 2. Human interference is still possible. However, certainly in repeat securities lending processes wherein all participants have already been identified, the complete process can be executed automatically. Steps can be initiated when required by a controlling program, such as a Business Process Management (BPM) program that resides for instance on a server 208.

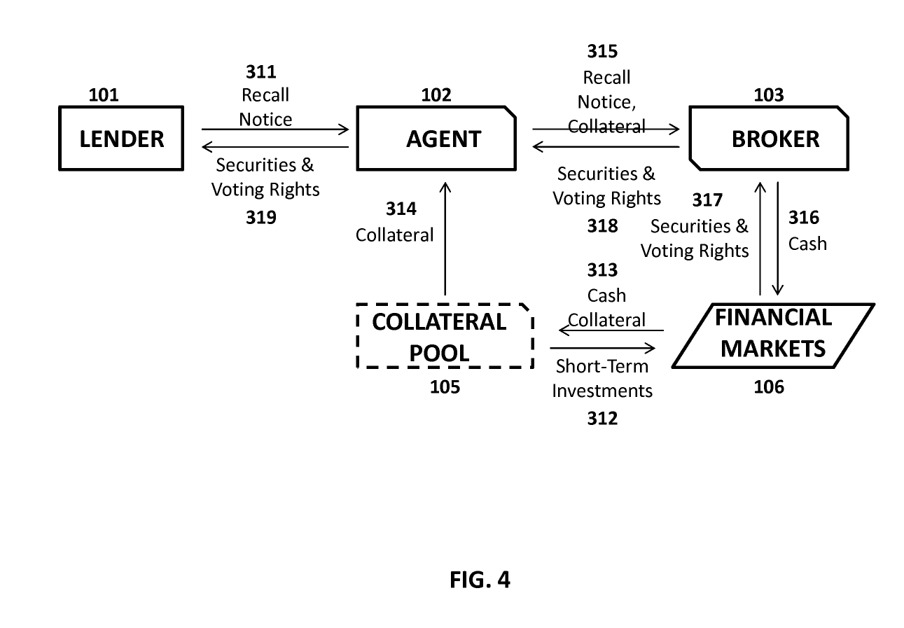

FIG. 4 illustrates a loan recall and termination process currently in use. When a lender wants to exercise voting rights related to the loaned securities, it has to recall the loan, as illustrated in FIG. 4. The Lender 101 issues a recall notice in a step 311 to its Agent 102, which then sells collateral investments in a step 312 to the Financial Markets 106 to generate cash in a step 313. The Agent 102 then withdraws collateral from the Collateral Pool 105 in a step 314 and passes the recall notice and collateral to Broker 103 in step 315. The Broker 103 uses the collateral in a step 316 to purchase securities (and voting rights) from the Financial Markets 106 in a step 317. The Broker 103 passes the securities (and voting rights) in a step 318 to Agent 102, which forwards it to the Lender 101 in a step 319. To ensure they have the voting rights, lenders must receive the securities and voting rights prior to the proxy record date.

Some markets do not have proxy record dates, but have voting cutoff dates or other proxy process milestones which are functionally equivalent for the purposes of this invention. Accordingly, references in this document to record dates are meant to include voting cutoff and similar dates.

Currently, recalling shares (i.e., terminating the securities loan) is the only way a lender can obtain the voting rights of the loaned shares. Breaking up a loan that is financially beneficial for the lender and borrower only to re-obtain the voting rights is not very efficient or cost-effective. Thus novel and improved methods and apparatus for securities lending and specifically shares lending and obtaining voting right are required.

Under current processes, financial intermediaries obtain large numbers of securities through the normal course of business, independent of securities lending or borrowing. For example, global custodians hold many securities for their customers. Brokers hold proprietary securities (i.e., securities purchased by the broker with its own capital), securities purchased by broker customers and held in brokerage accounts, securities posted for collateral in customer margin accounts, securities purchased by brokers as hedges for Exchange-Traded Funds, and securities received as collateral on the broker's securities loans. Other financial intermediary securities include shares held as collateral at central clearing agencies. These securities are accounted for in one embodiment of the present invention in a database, for instance a database that is under control or custody of the broker computer 203, wherein the relevant securities are administered and data related to the relevant securities and transactions for these securities are stored.

For various reasons, some securities held by financial intermediaries may go un-voted in corporate elections. For example, it is estimated that as many as 60 billion shares went un-voted in 2010 in the United States. Partially as a result, some companies are finding it difficult or more expensive to obtain the number of proxy votes to reach quorum at their proxy meetings.

Financial intermediary securities that would otherwise go un-voted therefore represent proxies that may be assigned to securities lenders through LDV, in accordance with aspects of the present invention. One aspect of the present invention encompasses all shares that represent available (un-voted) proxies. It is believed that under modified regulatory conditions with appropriate regulatory safeguards, the un-voted proxies could be made available for voting purposes to securities lenders. Furthermore, securities lending is a well established and legally controlled practice in different geographical areas with different regulatory limitations. What is a permitted practice in one geography may be severely limited or prohibited in another geography. Accordingly, the term “un-voted shares” herein is intended to mean during the performance or implementation of one or more aspects of the present invention: all shares which have voting rights related to a company, which votes can actively be exercised by the financial intermediary, but which rights are not being actively exercised.

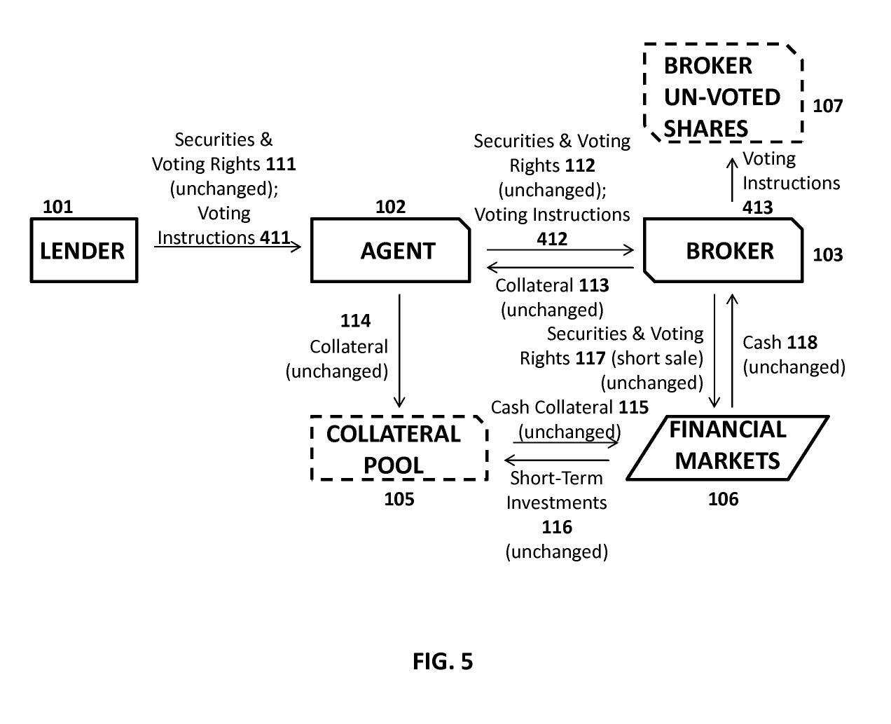

The availability of un-voted proxies that can be voted provided by aspects of the present invention offers an opportunity to allow lenders to vote shares in a company without having to recall a share loan as is illustrated in FIG. 5. Rather than recalling loans to obtain voting rights related to a company, in one embodiment of the present invention, the Lender 101 passes voting instructions to the Broker 103 in steps 411 and 412. The Broker 103 then applies these voting instructions in a step 413 to Broker Un-Voted Shares 107. FIG. 5 further illustrates that several steps that have to be reversed during a loan recall remain unchanged (e.g., steps 111, 112, 113, 114, 115, 116, 117, and 118), keeping the benefits of securities lending largely unchanged. In a further embodiment of the present invention, the Lender 101 passes voting instructions to its custodian or another financial intermediary, which applies the voting instructions to shares that would otherwise go un-voted. Each of the steps illustrated in FIG. 5 are performed by a processor in accordance

In accordance with an aspect of the present invention, un-voted shares are pooled in a database. In a further embodiment of the present invention, multiple financial intermediaries or sources of un-voted shares that could be voted are pooled in a database. A lender or a lender computer provides a voting instruction to a financial intermediary or a financial intermediary computer for instance via an agent or agent computer. The financial intermediary computer, in one embodiment of the present invention, checks how many shares the lender has loaned. The financial intermediary computer or a separate server then identifies available un-voted shares available for voting in a database. A processor then determines an amount of un-voted shares in a company that can be assigned for voting in accordance with lender instructions. Such assignment in one embodiment of the present invention is achieved by running an assignment algorithm. The processor in a further embodiment generates an instruction to execute the voting instruction of the lender for an agreed upon number of shares.

Furthermore, by using the automated infrastructure as, for instance, illustrated in FIG. 2 most, if not all steps of obtaining the voting rights can be achieved in an efficient and timely manner, while maintaining an accurate administration that is open to regulatory control.

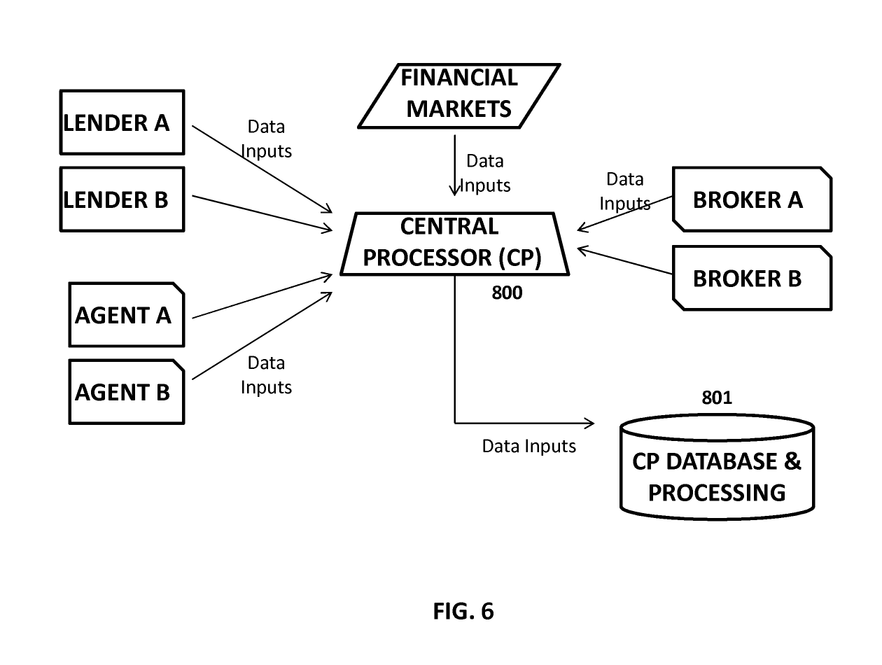

As illustrated in FIG. 6, in one embodiment of the present invention, a common system is implemented by pooling data from different sources in a system that contains a Central Processor (CP) 800 (which may be a server 208 as shown in FIG. 2) and a CP Database & Processing computer (Database) 801 (which may also be a server 208 as shown in FIG. 2). Thus, data from a plurality lenders, such as LENDERS A and B, from a plurality of agents, such as AGENT A and B, from a plurality of brokers, such as BROKER A and B and from the financial markets can be input to the CP 800 for processing and for storage in the CO database 801.

In one embodiment of the present invention, the data will be collected by CP 800 and transferred to the Database 801 for storage, aggregation, transformation, and processing. Data stored in Database 801 can be transformed and processed in three computational “Engines” (E1, E2, and E3) to produce outputs that are transferred via computer messaging to lenders, agents, financial intermediaries, and preferably their computers. The outputs include forecasts of future vote supply (E1), loan allocations that would increase matching between vote demand and supply (E2), and assignments of broker vote supply to lenders based on lender vote demand and loan volume (E3).

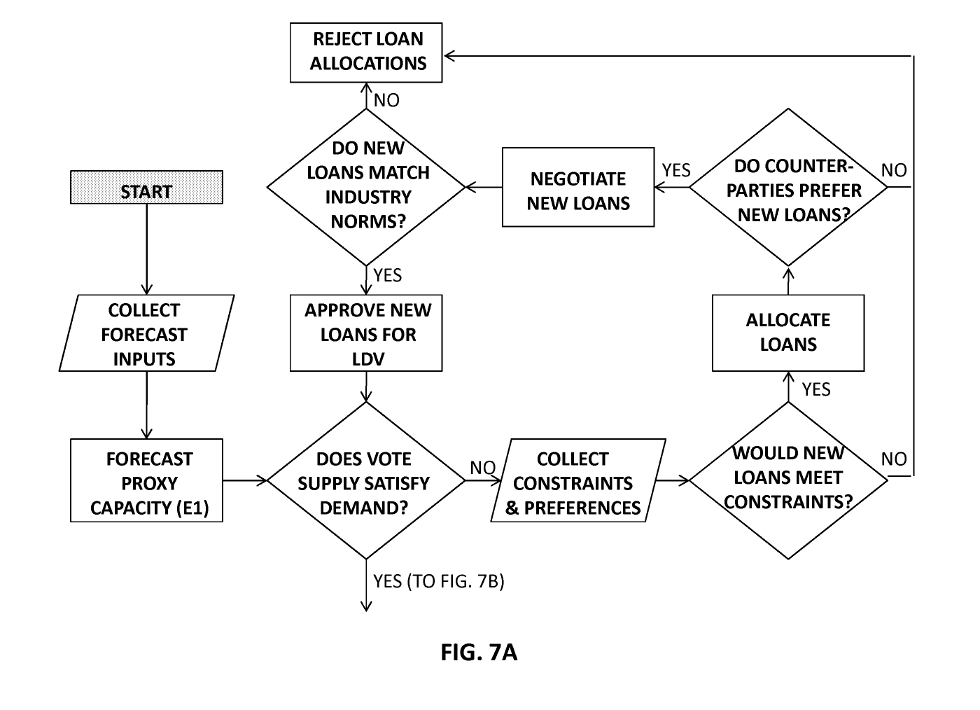

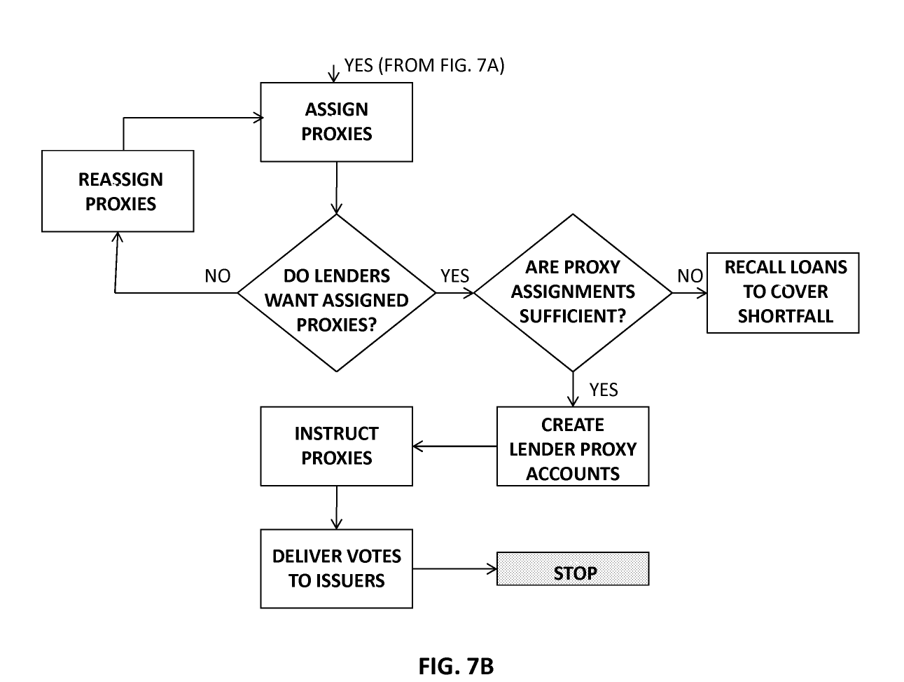

FIG. 7 illustrates a logical decision tree that could be implemented by CP 800 to determine data flow into and between E1, E2, and E3. CP 800 begins the LDV process by collecting in step D1.0 data that is needed to forecast the number of un-voted proxies of financial intermediaries. E1 is then implemented in step D2.0 and the forecasted proxy capacity is compared to vote demand (i.e., loan volume) in step D3. If the forecasted vote supply is less than vote demand, then allocations of loans between lenders and brokers, when the financial intermediary is a broker, are calculated to better align vote supply and demand. Lender and broker constraints and preferences are collected in step D3.1, then preliminary loan allocations are compared to those constraints in step D3.2, thereby ensuring that new loans are consistent with lender and broker preferences. After constraints are met, final loan allocations are calculated in step D3.3. Lenders and brokers review loan allocations in step D3.4 and approve those they find beneficial (given other loan factors such as pricing, stability, etc.). Approved loans terms are negotiated between the lenders and brokers in step D3.5, then those terms are compared to industry norms in D3.6. New loans that are consistent with industry norms are approved for assignment of proxies in the LDV process in step 3.6.1. Loans that are inconsistent with industry norms, as well as those that do not meet lender or broker constraints or preferences, are rejected for LDV processing in step 3.6.2. After loans are allocated, proxies are assigned from financial market intermediaries to lenders in step D4.0. Lenders determine whether they want to vote the proxies in step D5.0, and any unwanted proxies are reassigned to other lenders in step D5.1. Lenders also determine if their proxy assignment provided enough votes to cover their loaned shares in step 6.0 and, if their proxy assignment is insufficient, may recall loans in step D7.0 to ensure they receive proxy voting rights for all their shares. Financial intermediaries create proxy accounts for the lenders in step D8.0 to distribute the proxies to the lenders. In turn, the lenders instruct the proxies in step D9.0, after which the votes are tallied and forwarded to the corporate issuer in step D10.0.

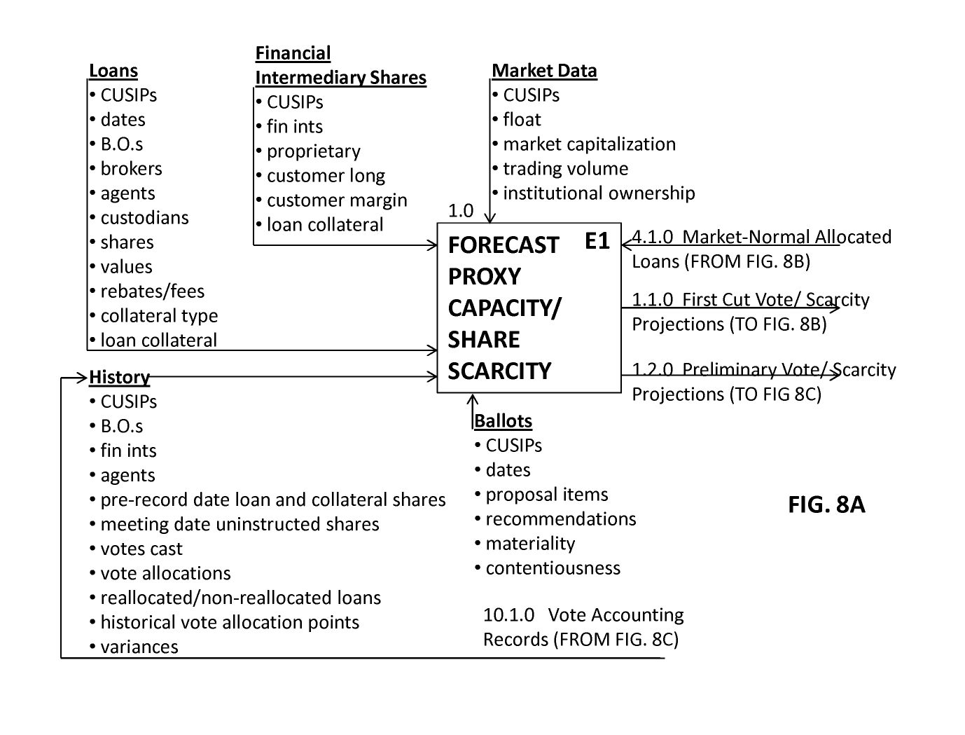

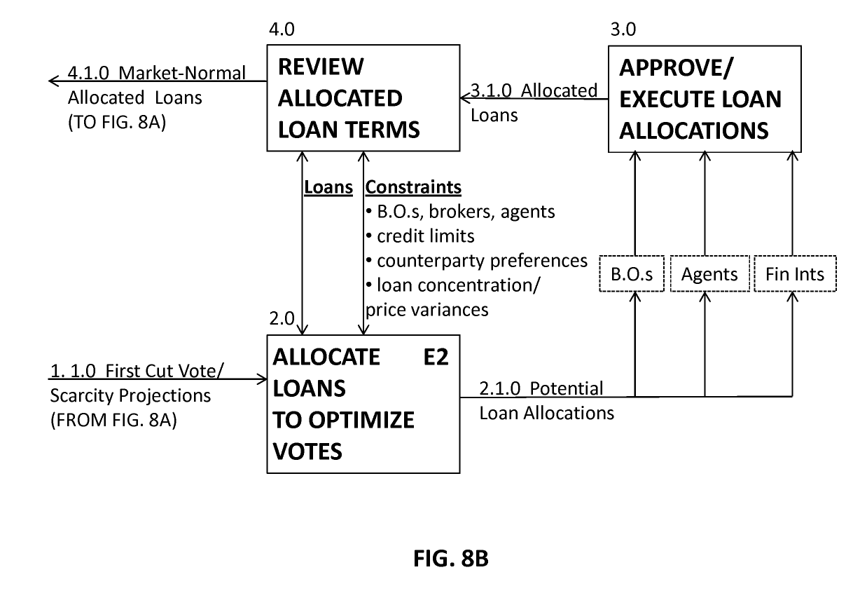

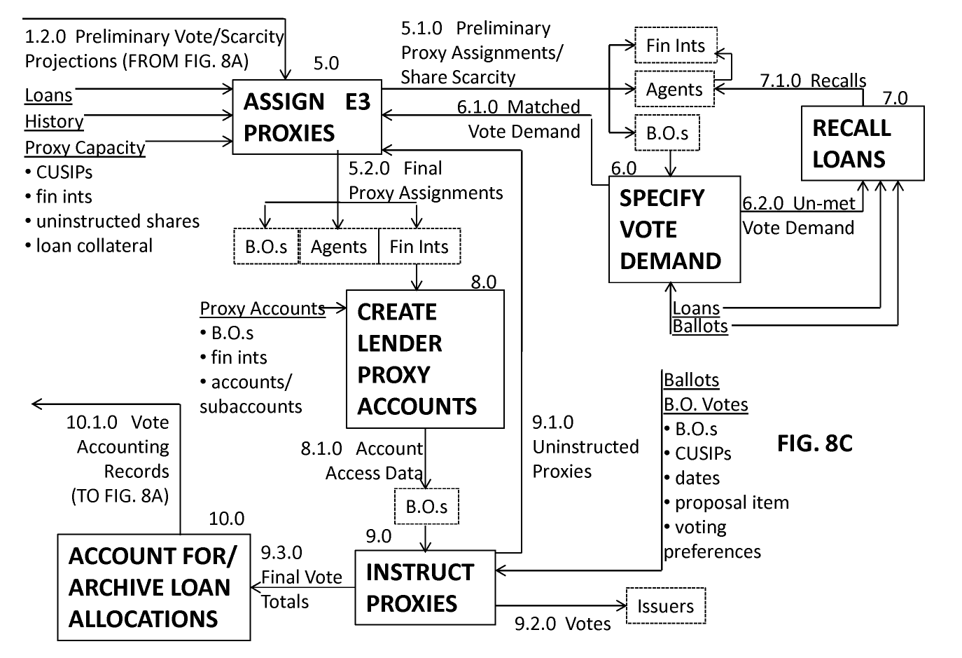

FIG. 8 illustrates the data elements stored in the Database 801 and the functions performed by CP 800 on data in Database 801 as they relate to each of the three computational Engines.

Data Collected by CP 800 Would Include:

Financial intermediary shares, which specify the number of shares held by financial intermediaries such as brokers and custodians prior to record date, by various ownership and account types. Data include CUSIPs (and/or other security identifiers), financial intermediary identifiers, and the number of proprietary, customer long, customer margin, and loan collateral shares. Data are used to forecast before record date the proxy capacity of financial intermediaries (Engine 1, Process 1.0). Data are initially collected, then again after any loan allocations that result from Processes 2.0, 3.0, and 4.0.

Ballots, which specify proxy proposal items, as well as proxy service provider voting recommendations and various measures of the proxy materiality and contentiousness. Data include CUSIPs (and/or other security identifiers), dates, proposal items, proxy service provider recommendations, and measures of materiality and contentiousness. Data are used to forecast proxy capacity, by lenders to determine voting demand (Engine 1, Process 1.0), in specifying vote demand (Process 6.0), and again by lenders when instructing proxies (Process 9.0).

Loans, which specify loans outstanding between various lenders, agents, and brokers, as well as the terms of those loans, especially loan pricing. Data include CUSIPs (and/or other security identifiers), dates, beneficial owner, broker, agent, and custodian identifiers, loaned shares, value, and collateral, rebates/fees, and collateral type. Data are used repeatedly in LDV processes, including forecasts of proxy capacity (Engine 1, Process 1.0), to review prices of new loans negotiated in Process 3.0, to determine lender vote demand and loan recalls in Processes 6.0 and 7.0, in the assignment of proxies to lenders, brokers, and custodians (Engine 3, Process 5.0), and when accounting for/archiving loan allocations (Process 1.0). Data are initially collected, then again after any loan allocations that result from Processes 2.0, 3.0, and 4.0, then a final time as of record date. The Loans file may be submitted by beneficial owners, their securities lending agents, or by brokers from the Principal Allocation Information contained in the Daily File they receive as part of the Agent Lender Disclosure Initiative.

Market data, which specify various characteristics of the shares on loan. Data include CUSIPs (and/or other security identifiers) and issuer float, market capitalization, trading volume, and institutional ownership. Data are used to forecast proxy capacity and share scarcity in securities lending markets (Engine 1, Process 1.0).

History, which specify past proxy assignments, proxy capacity, loan allocations, and any LDV process variances that impacted proxy assignments. Data include CUSIPs (and/or other security identifiers), beneficial owner, financial intermediary, and agent identifiers, pre-record date loan and collateral shares, meeting data uninstructed shares, votes cast, vote allocation, reallocated/non-reallocated loans, historical vote allocation points, and variances. Data are used to forecast proxy capacity (Engine 1, Process 1.0) and in the proxy assignment process (Engine 3, Process 5.0) to ensure equitable distribution of proxies to lenders, brokers, and custodians over time. Data recorded in Process 10 are used to update the History file.

Constraints, which specify any limitations on loan allocations that would otherwise maximize LDV proxy assignments, as well as loan price variation limits. Data include beneficial owner, broker, and agent identifiers, credit limits, counterparty preferences, and loan concentration/price variances. Data are used to limit loan reallocations in Process 2.0 and to prevent any loans with abnormal prices from receiving proxy assignments in Process 4.0

Proxy capacity, which specify the proxy capacity of financial intermediaries beginning 10 days before meeting date. Data include CUSIPs (or other security identifiers), financial intermediary identifiers, uninstructed shares and loan collateral. Data are used to generate the final assignment of proxies to match lender demand (Engine 3, Process 5.0) consistent with loan volumes contained in the record date Loan file.

Proxy accounts, which specify beneficial owner accounts managed by financial intermediaries for the purpose of proxy distribution. Data include beneficial owner and financial intermediary identifiers and beneficial owner subaccount identifiers. Data are used by financial intermediaries to distribute proxies assigned by LDV to beneficial owners in Process 8.0.

Beneficial owner votes, which specify the voting preferences of beneficial owners. Data include beneficial owner identifiers, CUSIPs (or other security identifiers), dates, proposal items, and voting preferences. Data are used to instruct proxies assigned to them by LDV in Process 9.0.

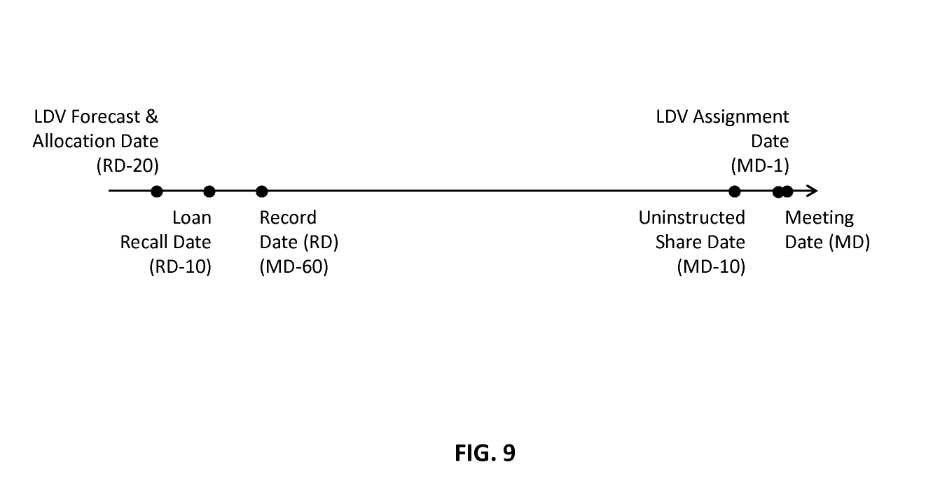

E1 (Process 1) forecasts before record date the proxy capacity of financial intermediaries such as brokers and custodians, as well as the scarcity of the shares in the securities lending market. Under current processes, securities lenders who wish a high degree of certainty in voting their loaned or collateralized shares must recall those shares from brokers and counterparties before the record date. By doing so, the shares will be re-registered in their names or nominees on record date and they will receive associated proxies. To allow sufficient time to receive and re-register shares, lenders must issue recall notices approximately 10 days before the record date, as shown in the generic proxy timeline in FIG. 9. Through LDV, lenders and collateral providers can obtain proxies for some or all loaned shares without recalling those shares. If LDV cannot provide enough proxies to cover all loaned shares, however, lenders may still issue recall notices for at least some of the loaned shares. However, it cannot be determined until immediately before meeting date exactly how many proxies that lenders will be assigned because financial intermediary share positions change and varying numbers of investors actually vote. To better inform lenders' pre-record date recall decisions, E1 therefore forecasts the number of proxies that lenders will receive through LDV. As a byproduct, El also forecasts the scarcity of shares in the securities lending market, which further helps lenders make informed recall decisions, particularly with regard to recall timing.

E2 (Process 2.0) allocates loans to optimize votes. It is possible, even likely, that existing securities lending processes will result in lender-broker loan volumes that do not maximize the capability of brokers to assign proxies to securities lenders. For example, a broker may have loans from a particular lender, but no proxy capacity. Another broker could have capacity, but no loans from that lender. In such cases, E2 generates, based on proxy capacity forecasts from E1, potential loan allocations between lenders and brokers that would increase the volume of lender vote demand that could be satisfied. Of course, allocations are constrained by numerous factors, such as counterparty credit limits and preferences, as stipulated in the Constraints file.

In Process 3.0 loan allocations are approved/executed. Many factors are considered when making securities loans, including loan demand; share scarcity, liquidity and concentration; loan prices, trends and volume; collateral and counterparty quality; the term structure and direction of interest rates; counterparty credit limits and tendencies; and, lender and broker relationship preferences. Accordingly, some loan allocations that would maximize the volume of broker proxy capacity that could be allocated to lenders through LDV may not be executed. Lenders, agents, and brokers review loan allocations generated by E2 and approve those allocations they find advantageous. Agents and brokers execute approved allocations and negotiate terms of any new loans.

In Process 4.0 allocated loan terms are reviewed. It is critical that LDV not result in a “market for votes,” or that proxies be traded for beneficial loan terms, leveraged for additional business, or exchanged for any other value. Accordingly, loans negotiated in Process 3.0 as part of the allocation process will be reviewed to ensure consistency with standard securities loan prices, concentration, and other market statistics. Any loans that are inconsistent with market norms, as defined by loan concentration and price variance limits in the Constraints file, will not be assigned proxies by LDV. The loan pricing engine described in the initial patent application will be used to determine the reasonability of the prices of any allocated loans.

E3 (Process 5.0) assign proxies. At the heart of LDV is the assignment of financial intermediary proxy capacity to match lender vote demand. E3 proportionately and mechanistically assigns proxies across lenders, brokers, custodians, and other financial market intermediaries, thereby ensuring assignments are not biased, e.g., intended to leverage other business lines. The maximum number of votes a lender can receive through LDV is the number of shares of an issue it had on loan on record date, since that is the total number of shares for which the lender was the beneficial owner but not in possession of on the record date. LDV will remain a “best-efforts” process, as financial intermediary share positions change daily and their customers vote in varying numbers over time and across issues.

In Process 6.0 vote demand is specified. Upon receipt of preliminary proxy assignments from E3, lenders determine their level of interest in the proxy event. If they are indifferent about the corporate election, they may choose to forgo their proxy assignment, which results in those proxies being reassigned to other lenders. Conversely, lenders with an interest signal their desire to vote their assigned proxies, which is factored into the final proxy assignment. In making these determinations, lenders rely on proxy item descriptions contained in the Ballot file, as well as comparisons of proxy assignments to loan volumes in the Loans file.

In Process 7.0 loans are recalled. If their assignment is insufficient to cover the number of shares they have on loan, lenders may issue recall orders to cover the shortfall so loaned shares can be returned and re-registered in their names prior to record date. Upon receipt of a recall notice, agents attempt to reallocate that loan to another of their customers. If reallocation is not possible, perhaps because the security is especially scarce in the securities lending market, agents pass the recall notice on to brokers, who then are required to return the security to the lender. As in Process 6.0, they rely on data in the Loans and Ballot files when making recall decisions.

In Process 8.0 lender proxy accounts are created. A few days before record date, E3 generates a final assignment of proxies across lenders, brokers, custodians, and other financial market intermediaries. Financial market intermediaries then distribute proxies to lenders consistent with the allocation file generated in Process 5.0. They do so, for example, by creating subaccounts for the lenders in their Proxy Accounts file, then distributing proxies to those subaccounts. Financial market intermediaries then provide lenders with subaccount access information.

In Process 9.0 proxies are instructed. After proxies are distributed in Process 8.0, lenders instruct or vote the proxies according to their voting preferences as specified in the Beneficial Owner Votes file. Immediately before meeting date, any proxies that remain uninstructed in this Process are reassigned to other lenders to maximize the amount of financial market intermediary proxy capacity that is utilized. On meeting date, proxies are tallied and the votes are passed to the corporate issuer consistent with existing proxy system processes and conventions.

In process 10.0 loan allocations are accounted for and archived. After votes are tallied in Process 9.0, a final accounting is conducted to ensure as many proxies as possible were utilized by LDV. Comparisons are made to the record date Loan file to ensure allocation of proxies was proportional, given loan volumes, proxy capacity, lender voting demand and any proxies reassigned in Process 9.1.0. Vote allocations and LDV process variances are also entered into the History file to calibrate future iterations of LDV and to ensure that lenders, brokers, custodians, and other financial market intermediaries receive equitable allocations of proxies over time.

E1 is a multiple regression that forecasts the proxy capacity of participating financial market intermediaries, based on various data factors/inputs collected 20 days before record date:

PROJ(VOTES_{sb})=f(BroCus_{b}, SP_{sb}, SL_{sb}, SM_{sb}, PCₛ, LP_{sb},)

so that proxy capacity across all participants is:

PROJ(VOTESₛ)=ΣPROJ(VOTES_{sb}) (b=1 to n)

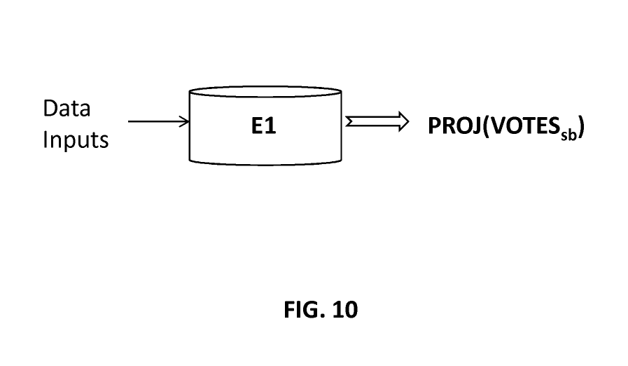

E1 is regularly calibrated as more current data becomes available, which constantly improves the accuracy of the projections. Other factors may also be included in the multiple regressions, such as collateral shares, issues' market capitalization, float, trading volume, and institutional ownership, as well as proxy materiality and voting recommendations. Functional specifications for E1 are illustrated on FIG. 10. An example of implementing E1 is included below.

E2 is a linear program that simultaneously solves equations that a) calculate the optimal lender-to-broker loan allocation that would maximize the extent to which proxy capacity would be matched with lender vote demand, so:

ΣΣVA_{sb1} (b=1 to n, 1=1 to n)=MAX(VAₛ)

and b) hold constant the number of shares loaned by securities lenders:

ΣLVOL_{sb1} (b=1 to n)=LVOLₛ₁=OPT(LVOLₛ₁)=ΣOPT(LVOL_{sb1}) (b=1 to n)

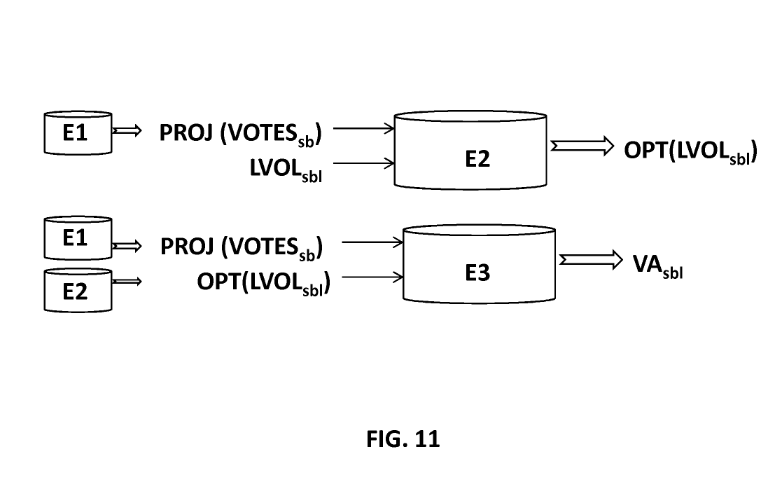

Functional specifications for E2 are illustrated on FIG. 11. An example of implementing E2 is included below.

E3 is a linear program that proportionally assigns available proxies across lenders, brokers, custodians, and other financial market intermediaries according to their shares of overall vote demand and supply, respectively. So:

$$\frac{\sum {VA}_{sb 1} ( b = 1 to n )}{\sum \sum {VA}_{sb 1} ( b = 1 to n , 1 = 1 to n )} = \frac{\sum {LVOL}_{sb 1} ( b = 1 to n )}{\sum \sum {LVOL}_{sb 1} ( b = 1 to n , 1 = 1 to n )}$$

where ΣVA_{sb1} (b=1 to n)<=ΣLVOL_{sb1} (b=1 to n)

and ΣVAₛ₁₁ (1=1 to n)<=VOTES_{sb}

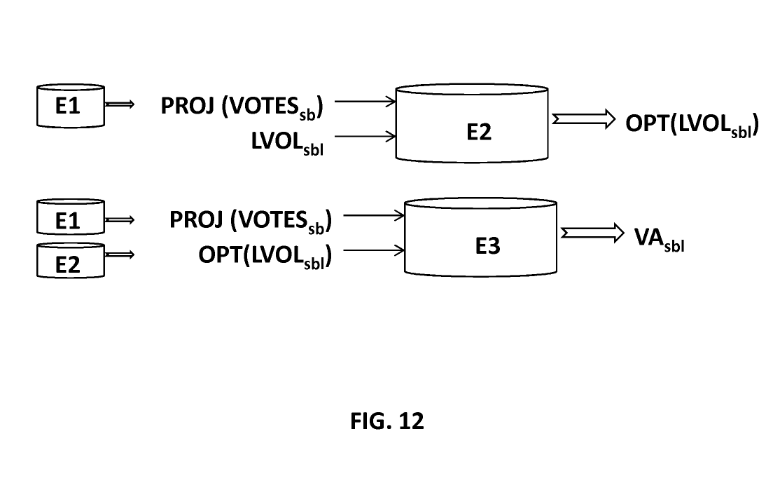

During one LDV cycle, E3 can be executed twice. On the second of these iterations, following Process 6.0, lender vote demand is incorporated in E3. Structurally, however, the Engine remains the same. Furthermore, another embodiment of the present invention would integrate Historical Allocation Points (points assigned to lenders, brokers, custodians, and other financial market intermediaries for allocated proxies) into this engine to ensure equitable distribution of voting opportunities over time. Functional specifications for E3 are illustrated on FIG. 12. An example of implementing E3 is included below.

A glossary for terms used in the preceding three paragraphs is:

VOTES_{sb}=Shares of issueₛ for which BroCus_{b} has not received voting instructions leading up to meeting date

BroCus_{b}=A particular broker, custodian, or other financial market intermediary, denoted by subscript b

SP_{sb}=Proprietary shares of issueₛ held by BroCus_{b}

SL_{sb}=Customer long shares of issueₛ held by BroCus_{b}

SM_{sb}=Customer margin shares of issueₛ held by BroCus_{b}

PCₛ=Measure of proxy contentiousness for issueₛ as determined by proxy service providers

LP_{sb}=Average loan price (rebates for cash loans, fees for non-cash loans) paid by BroCus_{b} for issueₛ

PROJ=Denotes a projection of another variable. For example, PROJ(VOTES_{sb}) is the projection before record date of the proxy capacity of issueₛ that BroCus_{b} will have leading up to the meeting date

LVOL_{sb1}=Number of shares of issueₛ loan by lender₁ to BroCus_{b}

OPT=Denotes a variable that has been optimized to maximize vote allocations. For example, Opt(LVOL_{sb1}) is the loan volume of issueₛ between lender₁ and BroCus_{b} that would result in the highest vote assignments

VA_{sb1}=The number of proxies of issueₛ assigned from BroCus_{b} fee to lender

Other terms used herein and their definitions include:

Lender₁=A particular lender, denoted by subscript 1.

Issueₛ=A particular issue, denoted by subscripts.

CUSIPₛ=Standard security identifier for issueₛ used to link data from multiple sources.

MF₁=One-month average of daily float of issueₛ.

MCₛ=Market capitalization of issueₛ

MVₛ=One-month average daily trading volume of issueₛ.

MOₛ=% institutional ownership of issue,

PRₛ=Percent of issueₛ ballot items for which proxy service providers recommend supporting management.

PMₛ=Measure of proxy materiality for issueₛ as determined by proxy service providers.

VOTEDₛ₁=Number of issueₛ votes demanded by lender₁.

HAP₁=Historical allocation points of lender.

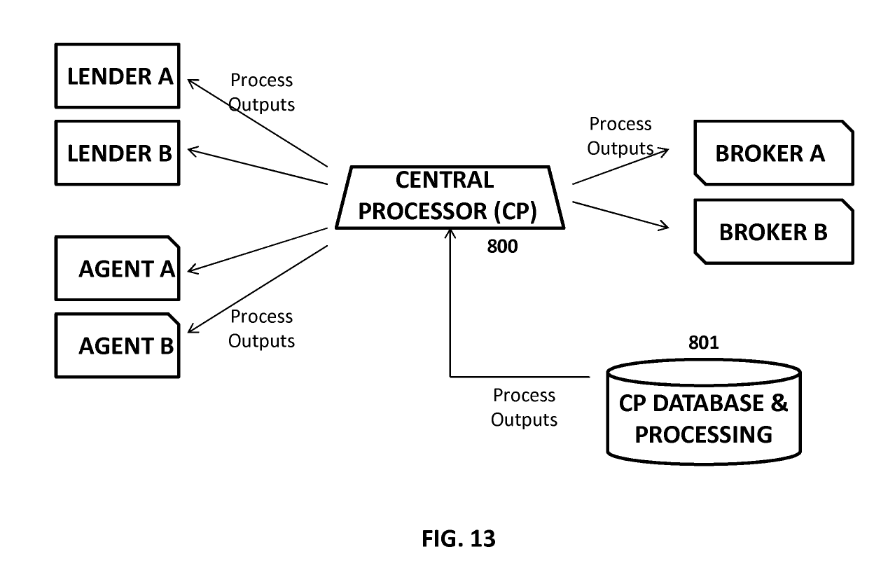

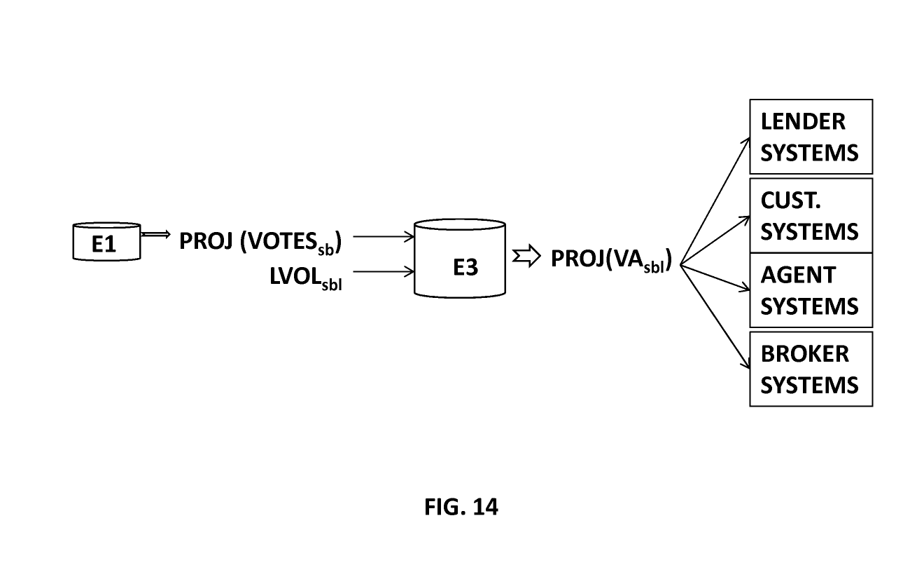

FIG. 13 illustrates an output of a system in accordance with an aspect of the present invention. The Database 801 will pass process outputs to the CP 800, which will transmit those outputs to Lenders, Agents, Brokers, and other financial market intermediaries and preferably their computers via electronic messaging. Outputs for E1, E2, and E3 are further illustrated on FIGS. 14, 15, and 16, respectively.

The CP will also provide Accounting Reports to all participants and preferably to computers of all participants to provide financial accounting and to ensure the equitable assignment of voting opportunities.

The following provides an example of the processing performed by Engine 1 (E1) in accordance with an aspect of the present invention. E1 generates a forecast before the record date of the number of proxies custodians and brokers will have available on the meeting date. That is, it forecasts proxy capacity, or the number of proxies that could be allocated to institutional securities lenders through LDV. As mentioned above, this forecast will be critical to securities lenders who need to decide before record date whether or not to recall loans to reacquire voting rights. If the forecast suggests that sufficient proxies will be available through LDV, those lenders may choose not to recall existing loans. E1 forecasts are based on numerous variables, as explained in preceding sections. For illustration, the following table depicts some of these variables for a selection of companies (please refer to the glossary for variable definitions). VOTES, SP, SL, SM, and PROJ(VOTES) expressed in thousands of shares; PC: 1=not material, 2=somewhat material, 3=material; LP expressed in basis points. The El multiple regression can include other factors, such as MC, MF, MO, PR, LVOL, and History variables discussed above, as well as other factors, without changing the structure of the engine, even though they are not shown in this example. Note that VOTES represents the number of proxies that were available on meeting date, while all other data are from before the record date.

| Company | VOTES | BroCus | SP | SL | SM | PC | LP |
|---|---|---|---|---|---|---|---|
| Verizon | 4,646 | 1 | 2,313 | 13,171 | 4,116 | 2 | 14 |
| Communi- | | | | | | | |
| cations | | | | | | | |
| Ford Motor | 18,287 | 1 | 6,673 | 78,043 | 11,992 | 1 | 21 |
| NASDAQ | 289 | 1 | 118 | 952 | 286 | 2 | 17 |
| OMX | | | | | | | |
| United Online | 205 | 1 | 63 | 1,281 | 279 | 3 | 13 |
| Verizon | 21,197 | 2 | 3,953 | 71,247 | 16,732 | 2 | 21 |
| Communi- | | | | | | | |
| cations | | | | | | | |
| Ford Motor | 36,500 | 2 | 13,103 | 93,728 | 26,875 | 1 | 16 |
| NASDAQ | 777 | 2 | 156 | 2,716 | 519 | 2 | 21 |
| OMX | | | | | | | |
| United Online | 297 | 2 | 173 | 1,511 | 217 | 3 | 22 |

Multiple regression techniques can then be applied to this data to determine the relationship between VOTES and the other variables. The regression output, which is shown in the following table, is a series of weights for each variable that specifies the extent to which it affects VOTES. For example, for each share held in a proprietary account (SP) before record date, 0.5 proxies will be available on meeting date. Conversely, as the materiality of the proxy event increases (PM), the number of available proxies is forecasted to decline.

| | W1 | W2 | W3 | W4 | W5 | W6 |
|---|---|---|---|---|---|---|
| Model Weights | 818.0 | 0.5 | 0.1 | 0.9 | −123.1 | −61.3 |

By applying these regression weights to pre-record date data, it is therefore possible to project the number of proxies that will be available on meeting date. As shown in the table below, data is collected for a firm before record date, then matched with the regression output weights to generate a projection of available proxies. In this sample, 10.4 million proxies are projected to be available on meeting date.

| | PROJ(VOTES) | D1 | D2 | D3 | D4 | D5 | D6 |
|---|---|---|---|---|---|---|---|
| Yahoo | 10,371 | 1 | 4,338 | 32,400 | 7,525 | 3 | 14 |

where PROJ(VOTES)=(W1*D1)+(W2*D2)+(W3*D3)+(W4*D4)+(W5*D5)+(W6*D6)

The following provides an example of the processing performed by engine 2 (E2) in accordance with aspects of the present invention. E2 generates loan allocations that, if enacted, would optimize the extent to which lender demand could be matched to forecasted broker proxy capacity. If a lender has loans to a broker with no proxies, while another broker has capacity but no loans, then allocating some or all loans from the first broker to the second would increase the total number of proxies that could be voted. Of course, there are numerous factors that are considered when making loans, such as loan fees, counterparty credit and concentration limits, collateral quality and investment opportunities, and counterparty preferences; lenders and brokers may therefore wish to not enact all loan allocations that would maximize proxy voting potential. As a simple example, assume pre-optimized loan volume and forecasted broker vote supply are as shown in the following tables:

LVOL_{sbl}

| | Lender 1 | Lender 2 | Lender 3 | TOTAL |
|---|---|---|---|---|
| Broker 1 | 300 | 250 | 250 | 800 |
| Broker 2 | 200 | 100 | 500 | 800 |
| Broker 3 | 100 | 150 | 50 | 300 |
| TOTAL | 600 | 500 | 800 | 1,900 |

PROJ(VOTES_{sb})

| | Vote | Vote Overage |
|---|---|---|
| | Supply | (Shortage) |
| Broker 1 | 400 | −400 |
| Broker 2 | 600 | −200 |
| Broker 3 | 900 | 600 |
| TOTAL | 1,900 | 0 |

In this case, Brokers 1 and 2 are not projected by the processor to have enough votes to satisfy their lenders' aggregate demand (Broker 1 will be 400 votes short, while Broker 2 will be 200 short). Conversely, Broker 3 will have 900 votes and only 300 borrowed shares, so will have 600 more votes than it can assign to its lenders. Therefore, reallocating loans before the proxy record date from Brokers 1 and 2 to Broker 3 would increase the total number of votes that could be assigned to lenders. E2 calculates these reallocations, as shown in the following table:

| | | Loan | Loan | Loan | |
|---|---|---|---|---|---|
| | Overage | Realloca- | Realloca- | Realloca- | |
| | (Shortage) as a | tions, | tions, | tions, | |
| | % of LVOL | Lender 1 | Lender 2 | Lender 3 | TOTAL |
| Broker 1 | −50% | −150 | −125 | −125 | −400 |
| Broker 2 | −25% | −50 | −25 | −125 | −200 |
| Broker 3 | | 200 | 150 | 250 | 600 |
| TOTAL | | 0 | 0 | 0 | 0 |

To calculate reallocations with more brokers and lenders, standard linear programming solvers can be used, such as those available in Microsoft Excel.

Broker 1 has vote supply totaling only 50% of its loan volume (400 votes compared to 800 borrowed shares), while Broker 2 has supply totaling 75% (600 votes versus 800 borrowed shares). Therefore, their loan volumes are reduced for each lender by commensurate percentages (e.g., Brokers 1's loan volume with Lender 1 is reduced 50%, from 300 to 150 shares, and Broker 2′s loan volume with Lender 1 is reduced 25%, from 200 to 150). These loans are reallocated to Broker 3, who can therefore assign addition votes (e.g., Broker 3′s loan volume with Lender 1 is increased by 200 shares). Note that the total number of shares loaned by each lender remains constant throughout the reallocations, consistent with the constraints of E2.

The following is an example of the processing performed by engine E3. E3 assigns available proxies to securities lenders with an arms-length, mechanistic algorithm that ensures equitable treatment of lenders over time. Following the example above, assume that loan volume has been optimized by E2, so that loan volume between lenders and brokers as of record date is:

LVOL_{sbl}

| | Lender 1 | Lender 2 | Lender 3 | TOTAL |
|---|---|---|---|---|
| Broker 1 | 150 | 125 | 125 | 400 |
| Broker 2 | 150 | 75 | 375 | 600 |
| Broker 3 | 300 | 300 | 300 | 900 |
| TOTAL | 600 | 500 | 800 | 1,900 |

Then assume that broker vote supply just prior to the meeting date is shown in the following table:

VOTES_{sb}

| | Vote | Vote |
|---|---|---|
| | Supply | Coverage |
| Broker 1 | 320 | 80% |
| Broker 2 | 360 | 60% |
| Broker 3 | 1,200 | 133% |
| TOTAL | 1,880 | |

Note that vote supply differed somewhat from the projected votes supply, which is to be expected and which will result in some mismatches between vote demand and supply. In this case, Broker 1 had 80 fewer votes than was projected, Broker 2 had 240 fewer, and Broker 3 had 300 more. Broker 1 can therefore only cover 80% of its lenders' vote demand (320 vote supply/400 borrowed shares=80%), while Broker 2 can cover only 60% of demand (360/600=60%). Broker 3 can cover all of its lenders' vote demand. Therefore, applying these coverage percentages to lender broker loan volumes results in vote allocations of:

VA_{sbl}

| | Lender 1 | Lender 2 | Lender 3 | TOTAL |
|---|---|---|---|---|
| Broker 1 | 120 | 100 | 100 | 320 |
| Broker 2 | 90 | 45 | 225 | 360 |
| Broker 3 | 300 | 300 | 300 | 900 |
| TOTAL | 510 | 445 | 625 | 1,580 |

Note that no lender receives more votes that it has loans outstanding, while no broker allocates more votes than it has available, consistent with the constraints detailed above.

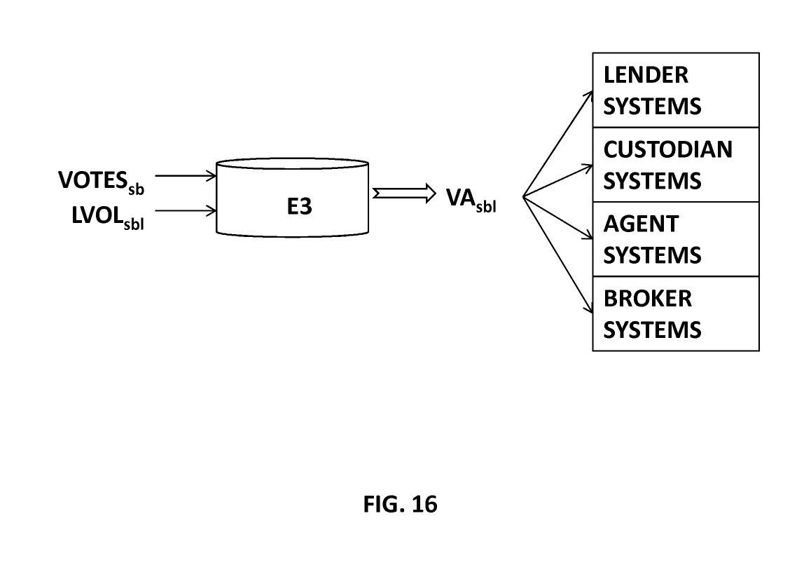

FIGS. 14, 15, and 16 further illustrate the processing computational engines in accordance with various aspects of the present invention. For example, FIG. 16 illustrates the processing of information to determine how to assign a company's proxies associated with a company's shares from a financial intermediary to a securities lender, First, a processor determines a number of the company's shares for which the financial intermediary has not received proxy voting instructions (VOTES_{sb}). Then, the processor determines for a plurality of lenders, the number of the company's shares loaned by each of the lenders (LVOL_{sb1}), Then for each of the plurality of lenders, the processor determines a number of the company's proxies for which the financial intermediary has not received proxy voting instructions to assign to at least some of the plurality of lenders based on the number of company's shares for which the financial intermediary has not received voting instructions and based on the number of shares loaned by the lender, consistent with the description of the E3 computational engine above.

The financial intermediary can be a broker, a custodian or any of the other entities in the financial marketplace that have been identified herein.

According to one aspect of the present invention, the processor's assignment of the number of proxies of un-voted shares by the financial intermediary is constrained by: (1) the lender's percentage share of assigned votes is equivalent to its percentage share of loan volume and (2) a lender can receive no more votes than it has loans outstanding.

In accordance with another aspect of the present invention, the processor does not permit the financial intermediary to assign more of the company's proxies than it has for which it has not received proxy voting instructions. Further, the processor can perform the steps of claim 1 for a plurality of financial intermediaries.

In accordance with further aspects of the present invention, the processor can determine to assign at least some of the number of the financial intermediary's un-voted proxies based on execution of a linear programming optimization model that maximizes the number of the financial intermediary's un-voted proxies that are voted, consistent with the description of the E3 computational engine above.

A system to provide these steps, as illustrated in FIG. 3, is also shown. The information needed can be stored in the memory 1202. The processor 1203 accesses the memory 1202 and processes information as illustrated in FIG. 16 and as described above.

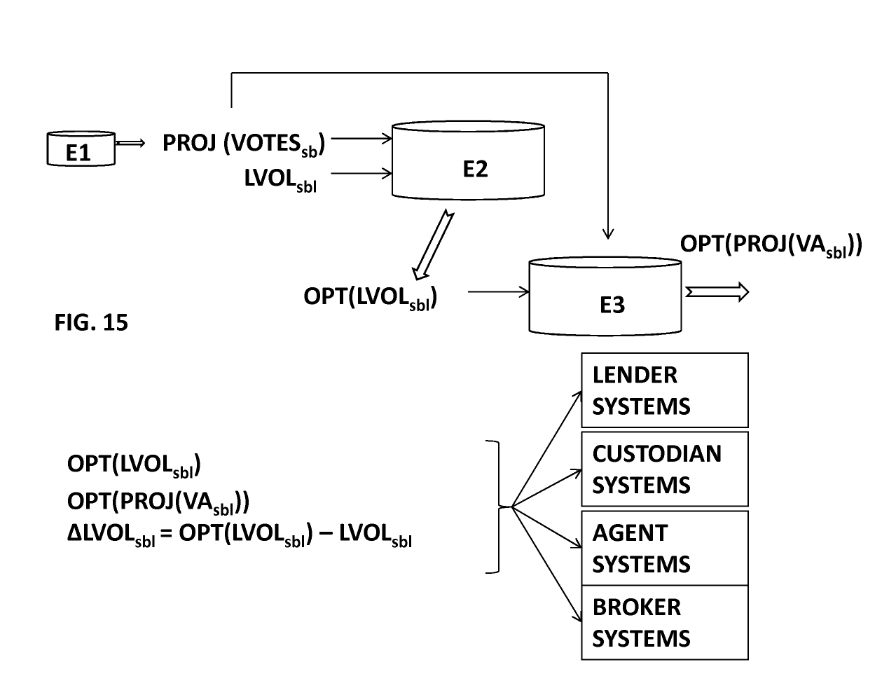

In accordance with further aspects of the present invention, and as explained earlier, before the processor performs the steps set forth above, the processor can make preliminary loan allocations. This can also be done periodically. FIG. 15 illustrates these steps. These steps can be performed for any financial intermediary, but is particularly applicable to brokers that borrow shares from lenders.

In accordance with an aspect of the present invention, the steps include with a processor, forecasting a number of the company's shares for which the broker will not receive proxy voting instructions. This is accomplished with engine E1, as explained earlier and as illustrated in FIG. 15. The output of engine E1 is PROJ(VOTES_{sb}) which is a projection, before a record date of the proxy capacity of issues that BroCus_{b} will have leading up to the meeting date. The processor then determines a proposed loan allocation of the company's shares between the plurality of lenders and the broker (OPT(LVOL_{sb1})) by using the forecasted number of the company's shares for which the broker will not receive proxy voting instructions PROJ(VOTES_{sb}) and loans of the company's shares between a plurality of lenders and the broker (LVOL_{sb1}). Then the processor transmits the proposed loan allocation to a third party. The third party can implement the proposed loan allocation.

In accordance with an aspect of the present invention and when the financial intermediary is a broker, the processor forecasts the number of the company's shares for which the broker will not receive proxy voting instructions by performing a multiple regression analysis on parameters selected from a group consisting of: a number of broker proprietary shares, a number of broker customer long shares, a number of broker customer margin shares, a measure of a type of the broker's customer base and proprietary voting preferences, a measure of a contentiousness of a proxy, and a market price for a loan of the company's shares.

In accordance with another aspect of the present invention, the proposed loan allocation of the company's shares between the plurality of lenders and the broker is determined on a processor by executing a linear programming optimization model that maximizes the number of the broker's un-voted proxies that could be assigned to lenders and is different than an actual loan allocation of the company's shares between the plurality of lenders and the broker.

In accordance with another aspect of the present invention, new loans resulting from the proposed loan allocation are reviewed by the processor to ensure consistency with standard securities loan prices, concentration, and other market statistics. It is to be understood that the lists of data elements and functions performed both above and in the attachment to this application are illustrative and should not be considered to be limiting.

U.S. patent application Ser. No. 61 /419,036, filed Dec. 2, 2010 and U.S. patent application Ser. No. 61/503,962, filed Jul. 1, 2011, are incorporated herein by reference.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method of assigning a company's proxies associated with a company's shares from a financial intermediary to a securities lender, comprising:
a processor determining a number of the company's shares for which the financial intermediary has not received proxy voting instructions;
the processor determining for a plurality of lenders, the number of the company's shares loaned by each of the lenders;
for each of the plurality of lenders, the processor determining a number of the company's proxies for which the financial intermediary has not received proxy voting instructions to assign to at least some of the plurality of lenders based on the number of company's shares for which the financial intermediary has not received voting instructions and based on the number of shares loaned by the lender.

2. The method of claim 1, wherein the processor's assignment of the number of proxies of un-voted shares by the financial intermediary is constrained by:
the lender's percentage share of assigned votes is equivalent to its percentage share of loan volume;
a lender can receive no more votes than it has loans outstanding.

3. The method of claim 1, wherein the financial intermediary can assign no more of the company's proxies than it has for which it has not received proxy voting instructions and the steps of claim 1 are performed for a plurality of financial intermediaries.

4. The method of claim 2, wherein the processor assigns at least some of the number of the financial intermediary's un-voted proxies based on execution of a linear programming optimization model that maximizes the number of the financial intermediary's un-voted proxies that are voted.

5. The method of claim 1, wherein the financial intermediary is a broker or a custodian.

6. The method of claim 5, wherein the financial intermediary is a broker and comprising, prior to the steps of claim 1:
with a processor, forecasting a number of the company's shares for which the broker will not receive proxy voting instructions;
with the processor, determining a proposed loan allocation of the company's shares between the plurality of lenders and the broker by using the forecasted number of the company's shares for which the broker will not receive proxy voting instructions and loans of the company's shares between a plurality of lenders and the broker; and
the processor transmitting the proposed loan allocation to a third party.

7. The method of claim 6, wherein the processor forecasts the number of the company's shares for which the broker will not receive proxy voting instructions by performing a multiple regression analysis on parameters selected from a group consisting of: a number of broker proprietary shares, a number of broker customer long shares, a number of broker customer margin shares, a measure of a type of the broker's customer base and proprietary voting preferences, a measure of a contentiousness of a proxy, and a market price for a loan of the company's shares.

8. The method of claim 6, wherein the proposed loan allocation of the company's shares between the plurality of lenders and the broker is based on execution of a linear programming optimization model that maximizes the number of the broker's un-voted proxies that could be assigned to lenders and is different than an actual loan allocation of the company's shares between the plurality of lenders and the broker.

9. The method of claim 6, wherein new loans resulting from the proposed loan allocation are reviewed by the processor to ensure consistency with standard securities loan prices, concentration, and other market statistics.

10. The method of claim 6, wherein the financial intermediary is a custodian comprising, prior to the steps of claim 1:
with a processor, forecasting a number of the company's shares for which the custodian will not receive proxy voting instructions by performing a multiple regression analysis on parameters selected from a group consisting of: a number of shares held by custodian, a measure of a type of the custodian's customer base, a measure of a contentiousness of a proxy, and a market price for a loan of the company's shares.

11. A system for assigning a company's proxies associated with a company's shares from a financial intermediary to a lender, comprising:
a memory storing a number of the company's shares for which the financial intermediary has not received proxy voting instructions and, for a plurality of lenders, the number of the company's shares loaned by the lender;
a processor having access to the memory, the processor determining a number of the company's proxies for which the financial intermediary has not received proxy voting instructions to assign to at least some of the plurality of lenders based on the number of company's shares for which the financial intermediary has not received voting instructions and based on the number of shares loaned by the lender.

12. The system of claim 11, wherein the processor's assignment of the number of proxies of un-voted shares by the financial intermediary is constrained by:
the lender's percentage share of assigned votes is equivalent to its percentage share of loan volume;
a lender can receive no more votes than it has loans outstanding.

13. The system of claim 11, wherein the financial intermediary can assign no more of the company's proxies than it has for which it has not received proxy voting instructions and the processor makes its determinations for a plurality of financial intermediaries.

14. The system of claim 12, wherein the processor assigns at least some of the number of the financial intermediary's un-voted proxies based on execution of a linear programming optimization model that maximizes the number of the financial intermediary's un-voted proxies that are voted.

15. The system of claim 11, wherein the financial intermediary is a broker or a custodian.

16. The system of claim 15, wherein the financial intermediary is a broker and the processor, before assigning at least some of the company's proxies for which the broker has not received proxy voting instructions,
the processor forecasts a number of the company's shares for which the broker will not receive proxy voting instructions;
the processor determines a proposed loan allocation of the company's shares between the plurality of lenders and the broker by using the forecasted number of the company's shares for which the broker will not receive proxy voting instructions and loans of the company's shares between a plurality of lenders and the broker; and
the processor transmits the proposed loan allocation to a third party.

17. The system of claim 16, wherein the processor forecasts the number of the company's shares for which the broker will not receive proxy voting instructions by performing a multiple regression analysis on parameters selected from a group consisting of: a number of broker proprietary shares, a number of broker customer long shares, a number of broker customer margin shares, a measure of a type of the broker's customer base and proprietary voting preferences, a measure of a contentiousness of a proxy, and a market price for a loan of the company's shares.

18. The system of claim 16, wherein the proposed loan allocation of the company's shares between the plurality of lenders and the broker is based on execution of a linear programming optimization model that maximizes the number of the broker's un-voted proxies that could be assigned to lenders and is different than an actual loan allocation of the company's shares between the plurality of lenders and the broker.

19. The system of claim 16, wherein new loans resulting from the proposed loan allocation are reviewed by the processor to ensure consistency with standard securities loan prices, concentration, and other market statistics.

20. The system of claim 16, wherein the financial intermediary is a custodian and the processor, before assigning at least some of the company's proxies for which the broker has not received proxy voting instructions, forecasts a number of the company's shares for which the custodian will not receive proxy voting instructions.
